(19) United States
(12) Patent Application Publication
(10) Pub. No.: US 2024/0265387 A1
(43) Pub. Date: Aug. 8, 2024

(54) METHOD AND SYSTEM FOR BLOCKCHAIN ITINERARY SUPPORT

(71) Applicant: Mastercard International Incorporated, Purchase, NY (US)

(72) Inventors: Shawn MEHRHOFF, St. Ann, MO (US); Jaipal Singh KUMAWAT, Sikar (IN); Christopher T. SCHOLL, Manchester, MO (US)

(21) Appl. No.: 18/105,330

(22) Filed: Feb. 3, 2023

(51) Int. Cl. G06Q 20/38; G06Q 20/42

(52) U.S. Cl. CPC G06Q 20/389; G06Q 20/42

(57) ABSTRACT

Methods and systems for management, payment, and real-time updating of travel itineraries using a blockchain includes: storing, in a blockchain, a plurality of smart contracts including funding transaction account data, payee data, an itinerary type, and itinerary details and configured to initiate a payment transaction from a first transaction account to a second transaction account upon fulfillment of criteria in the itinerary details; receiving event data including a conflict with the itinerary details of a smart contract; identifying alternative itinerary data for the smart contracts based on the respective itinerary details; generating a modified smart contract for the smart contracts based on the identified alternative itinerary data; and transmitting a new blockchain data entry that includes the generated modified smart contract for storing in the blockchain.

### FIELD

The present disclosure relates to the supporting of itineraries via a blockchain, specifically the use of blockchain for management, payment, and real-time updating of itineraries.

### BACKGROUND

Blockchains were first created as a way of providing for a cryptographic currency that could be transferred among participants in a decentralized manner that provided the participants with anonymity. Blockchains soon found use in a number of additional industries due to its immutable nature; because blocks cannot be edited or changed, blockchains are useful for storing data that can be later audited and/or used for proof of state, ownership, etc. at any time. As a result, blockchains have seen applications in voting, recording land ownership and transfers, and supply chain tracking and management.

Another aspect that led to the growth of use opportunities for blockchain is smart contracts. Smart contracts are self-executing applications stored on a blockchain that can monitor for set conditions and, when those conditions are met, execute in a predetermined manner to accomplish a further action. A common use for smart contracts is escrow: currency is transferred to an account controlled by the smart contract that waits for another transaction to take place (e.g., storing of a specific deed transfer in the blockchain), which executes to transfer the currency to the seller once the deed transfer is recorded or will execute to transfer the currency back to the buyer if the recordation does not happen before a specific deadline.

While blockchains have been used in applications in a number of industries, one industry that has not taken advantage of the new technology is travel. Traveling can often be as stressful as it is relaxing for many travelers due to the sheer number of objects on a travel itinerary. Even for the most basic vacations, a traveler can make a booking for a flight, a rental car, a hotel, and visiting attractions. Each of these objects can have different times and dates, different rules, and, for travelers looking to maximize rewards and minimize fees, different payment methods used to secure the booking. This results in a wealth of information that has to be managed and tracked by the traveler. Historically, some travelers have employed travel agents to manage itineraries on their behalf. However, travel agents still rely on humans to perform these functions on behalf of the traveler, which provides opportunity for error. In addition, when the unforeseen happens that can jeopardize a trip and require modification of an itinerary, assistance by a travel agent can only occur as quickly as the agent can become aware of the situation and then manually begin to explore options.

Thus, there is a need for a technological improvement to how itineraries are secured and managed, which can utilize blockchain to gain significant advantages over traditional methods.

### SUMMARY

The present disclosure provides a description of systems and methods for management, payment, and real-time updating of travel itineraries using a blockchain. When a traveler creates an itinerary, which can be done independently by the traveler or automated by the platform, the platform creates a smart contract for each item of the itinerary that is stored on a blockchain. Each smart contract has the itinerary details stored therein as well as payment information supplied by the traveler for the payment method they want to use for that specific item. The smart contract is configured to execute when criteria in the itinerary details are met, such as when the traveler has checked in for a flight, which results in a payment transaction being initiated for payment using the associated payment method to the appropriate provider. In the meantime, the platform receives event data that can affect itineraries, such as flight delays or cancellations, canceled or postponed events, etc. The platform checks received event data against smart contract itineraries and, when a conflict occurs (e.g., a flight reserved for a traveler has been canceled), the platform automatically and in real-time identifies a new itinerary item to replace the conflicted itinerary, and continues to do so for any other affected items (e.g., if a new flight requires a modified hotel reservation). For each new itinerary item, the platform generates a modified smart contract that is added to the blockchain. The result is that itineraries are automatically managed on behalf of travelers and can be modified and updated in real-time as necessary, providing for greater security and convenience than can be accomplished using traditional systems.

A method for management, payment, and real-time updating of travel itineraries using a blockchain includes: storing, in a blockchain associated with a blockchain network, a block including at least one blockchain data entry, the at least one blockchain data entry including a plurality of smart contracts, where each smart contract of the plurality of smart contracts (i) includes at least funding transaction account data, payee data, an itinerary type, and itinerary details and (ii) is configured to initiate a payment transaction from a first transaction account associated with the funding transaction account data to a second transaction account associated with the payee data upon fulfillment of one or more criteria included in the itinerary details; receiving, by a receiver of a processing server, event data, wherein the event data includes a conflict with the itinerary details of one or more smart contracts of the plurality of smart contracts; identifying, by a processor of the processing server, alternative itinerary data for each of the one or more smart contracts based on at least the respective itinerary details; generating, by the processor of the processing server, a modified smart contract for each of the one or more smart contracts, where each modified smart contract is modified based on the identified alternative itinerary data for the respective smart contract; and transmitting, by a transmitter of the processing server, a new blockchain data entry that includes the generated modified smart contract for each of the one or more smart contracts for storing in the blockchain.

A system for management, payment, and real-time updating of travel itineraries using a blockchain includes: a blockchain associated with a blockchain network, the blockchain storing a block including at least one blockchain data entry, the at least one blockchain data entry including a plurality of smart contracts, where each smart contract of the plurality of smart contracts (i) includes at least funding transaction account data, payee data, an itinerary type, and itinerary details and (ii) is configured to initiate a payment transaction from a first transaction account associated with the funding transaction account data to a second transaction account associated with the payee data upon fulfillment of one or more criteria included in the itinerary details; and a processing server including a receiver receiving event data, wherein the event data includes a conflict with the itinerary details of one or more smart contracts of the plurality of smart contracts, a processor identifying alternative itinerary data for each of the one or more smart contracts based on at least the respective itinerary details, and generating a modified smart contract for each of the one or more smart contracts, where each modified smart contract is modified based on the identified alternative itinerary data for the respective smart contract, and a transmitter transmitting a new blockchain data entry that includes the generated modified smart contract for each of the one or more smart contracts for storing in the blockchain.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for real-time management of travel itineraries using a blockchain in accordance with exemplary embodiments.

FIG. 2 is a block diagram illustrating the processing server in the system of FIG. 1 for real-time management of travel itineraries using a blockchain in accordance with exemplary embodiments.

FIG. 3 is a flow diagram illustrating a process for creation of travel itineraries on a blockchain as performed by the processing server of FIG. 2 in accordance with exemplary embodiments.

FIG. 4 is a flow diagram illustrating a process for real-time management of travel itineraries on a blockchain as performed by the processing server of FIG. 2 in accordance with exemplary embodiments.

FIG. 5 is a flow chart illustrating an exemplary method for management, payment, and real-time updating of travel itineraries using a blockchain in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### System for Real-Time Management of Travel Itineraries Using a Blockchain

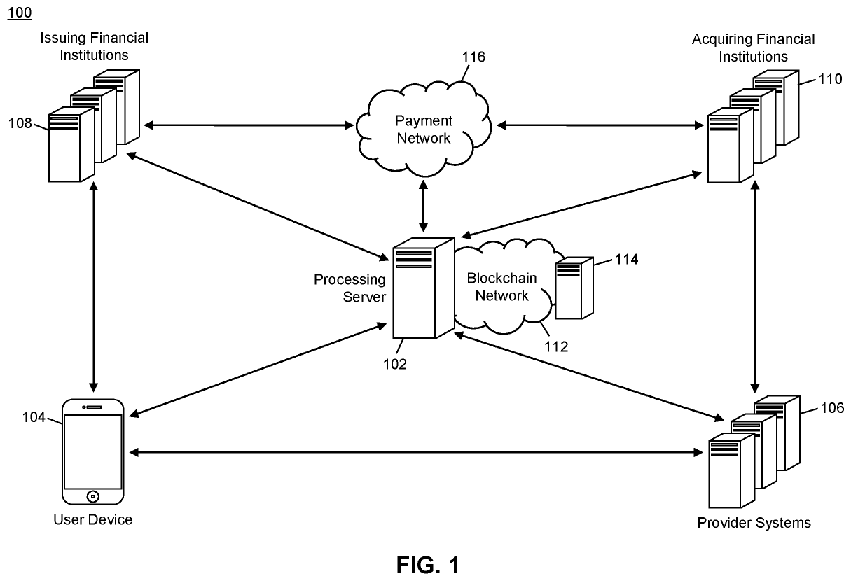

FIG. 1 illustrates a system 100 for management, payment, and real-time updating of travel itineraries using a blockchain.

The system 100 can include a processing server 102. The processing server 102, discussed in more detail below, can be configured to assist users (e.g., travelers) in the management of their travel itineraries including facilitating automatic payments and the real-time updating of itineraries when issues arise, such as flight cancellations, date changes for events, etc. The system 100 can also include a user device 104, which can be a computing device 104 utilized by the user for interacting with the processing server 102 and the rest of the system 100. The user device 104 can be any type of computing device suitable for performing the functions discussed herein, such as a desktop computer, laptop computer, notebook computer, tablet computer, cellular phone, smart phone, smart watch, smart television, wearable computing device, implantable computing device, etc.

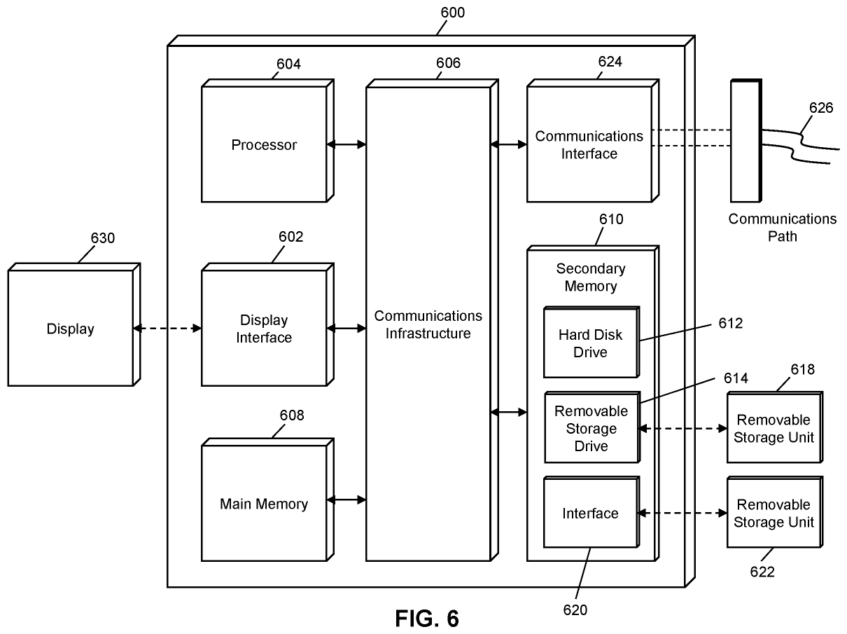

The system 100 can also include a blockchain network 112. The blockchain network 112 can be comprised of a plurality of blockchain nodes 114. Each blockchain node 114 can be a computing system, such as illustrated in FIG. 6, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 can be a blockchain node 114 in the blockchain network 112. In other embodiments, the processing server 102 can be configured to communicate with one or more blockchain nodes 114 in the blockchain network 112 using a suitable communication network and method.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 114 in the blockchain network 112 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 112 using the public key of the cryptographic key pair. In some cases, the term “blockchain wallet” can refer specifically to the private key. In other cases, the term “blockchain wallet” can refer to a computing device (e.g., user device 104, provider systems 106, etc.) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a user device 104) that is generated using the sender's private key, a blockchain address of the recipient of currency (e.g., a provider system 106) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 114 in the blockchain network 112, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 114 in the blockchain network 112 before being added to the blockchain and distributed to all of the blockchain nodes 114 in the blockchain network 112, respectively, in traditional blockchain implementations. In cases where a blockchain data value cannot be related to a blockchain transaction, but instead the storage of other types of data, blockchain data values can still include or otherwise involve the validation of a digital signature.

In the system 100, the blockchain network 112 can be used to store a blockchain that stores blockchain data values that include smart contracts associated with a user's overall travel itinerary, as discussed in more detail below.

The system 100 can also include one or more issuing financial institutions 108. Each issuing financial institution 108 can be a financial institution that issues a transaction account to the user associated with the user device 104 for use in funding electronic payment transactions, such as can be used by the user to pay for items in the user's overall travel itinerary. The issuing financial institution 108 can issue account details for the issued transaction account to the user device 104, which can be provided to the processing server 102 for inclusion in a smart contract for an itinerary item to be funded via the associated transaction account. Account details can include any data suitable for identifying the associated transaction account that can be included in a payment transaction that results in funding of the payment transaction via the associated transaction account.

The system 100 can also include one or more acquiring financial institutions 110. Each acquiring financial institution 110 can be a financial institution that issues a transaction account to a provider system 106 for use in receiving funds in electronic payment transactions, such as can be paid to the associated provider system 106 in exchange for providing a good or service to the user related to a travel itinerary item. The acquiring financial institution 110 can provide account details for the issued transaction account to a provider system 106, such as an account number and routing number, or a merchant identification number, which the provider system 106 can provide to the user device 104 or processing server 102 for inclusion in a smart contract for an itinerary item provided by the provider system 106 that is to be paid by the user to the provider system's transaction account. Provider systems 106 can be computing systems associated with a service provider that provides services to users related to travel itinerary items. Provider systems 106 can be computing systems associated with merchants such as airlines, hotels, rental car agencies, event venues, tour providers, restaurants, etc.

In the system 100, the user device 104 can register a trip with the processing server 102 using a suitable communication network and method. For instance, the user device 104 may execute an application program to collect travel itinerary items from the user for the trip, which can electronically transmit the collected data to the processing server 102. In another example, the user device 104 can navigate to a web page that collects the travel itinerary items via one or more forms on the web page that, when submitted, electronically transmit the collected data to the processing server 102. Each travel itinerary item can include at least funding transaction account data, payee data, an itinerary type, and itinerary details. The funding transaction account details can be sufficient details for use in identifying the associated transaction account in an electronic payment transaction that is to be used to fund payment for the associated itinerary item. The payee data can be data associated with the provider system 106 providing the associated itinerary item to be used in identifying the transaction account associated with the provider system 106 to receive the funds for the associated itinerary item. The itinerary type can be a category of the associated itinerary item, such as flight, rental car, train, boat, restaurant, hotel, concert, sporting event, tour, etc.

The itinerary details can include any additional information regarding the itinerary that can be used for any functions discussed herein, such as to provide information to the user about the itinerary item, used in facilitating payment of the itinerary item, etc. In some cases, the itinerary details can be based on the itinerary type. For instance, the itinerary details for a flight can be different from the itinerary details for a hotel reservation. Itinerary details can include, for example, ticket type or class, price, date, time, seat, flight number, fees, taxes, class, length, layover, street address, booking code, confirmation number, known traveler number, reward number, loyalty number, coupon code, etc.

The processing server 102 can receive the travel itinerary items from the user device 104 and, for each itinerary item, generate a smart contract. The smart contract can include all of the data provided for the itinerary item and be configured to, when executed, initiate a payment transaction from a transaction account associated with the funding transaction account data to a transaction account identified by the payee data for a price that is included in the itinerary details. The smart contract can be configured to self-execute upon fulfillment of one or more criteria included in the itinerary details. The one or more criteria can be based on the itinerary type and can vary as necessary as will be apparent to persons having skill in the relevant art. In an example, the criteria for a flight can be successful check-in by the user for the flight or within a predetermined time from the flight (e.g., three hours prior to departure time). The smart contract can monitor for fulfillment of the criteria and, when the criteria is met, execute to initiate the payment transaction to pay for the itinerary item. The smart contract can monitor for fulfillment by monitoring new blockchain data values added to the blockchain, using appropriate application programming interfaces (APIs) such as APIs with the appropriate provider systems 106, or other suitable methods.

In some cases, a smart contract can be configured to initiate a payment transaction for a varying price depending on fulfillment of criteria. For instance, the price may be a full amount if the user uses the associated service, but, if the user declines to use the service, the user can still be charged a portion of the price (e.g., 25% without proper cancellation notice). In such an instance, the smart contract can execute due to fulfillment of one criteria (e.g., passing of date and time of the reservation) but initiate the payment transaction for the reduced price due to non-fulfillment of a second criteria (e.g., response from an API for the hotel that the user did not check-in). When a smart contract is executed and initiates a payment transaction, the smart contract can submit an authorization request or other transaction message to a payment network 116. A payment network 116 can be configured to process electronic payment transactions using traditional methods and systems. The payment network 116 can receive the authorization request or other transaction message, which can include the funding transaction account details, payee data, and an amount, and facilitate payment from the issuing financial institution 108 to the acquiring financial institution 110 for the amount to resolve payment for the itinerary item by the user to the appropriate service provider.

In some embodiments, smart contracts can be configured to not execute if the one or more criteria is not fulfilled or to refrain from execution upon fulfillment of other criteria. For example, if a date and/or time passes without activation of an itinerary item (e.g., the user does not check-in for a reservation) then the smart contract may not execute to prevent payment by the user. In another example, the smart contract can detect a cancellation by the user (e.g., via an API with the associated provider system 106), which can result in the smart contract never executing to initiate the payment transaction. In some such cases, the smart contract can execute using the other criteria to transmit a notification to the user device 104 and/or provider system 106 indicating successful cancellation of the itinerary item.

In the system 100, the processing server 102 can be configured to receive event data. Event data can be received by the processing server 102 from the user device 104, provider systems 106, blockchain nodes 114, or any other suitable entity or system. Event data can include data that can affect one or more itinerary items that have associated smart contracts stored in the blockchain. Event data can include one or more data points that can be used to identify fulfillment of criteria of a smart contract or a conflict therewith. Event data can be related to, for instance, delay or cancellation of a flight, delay or cancellation of a tour, concert, or other event, check-in by a user for a flight or other reservation, change of class of a rental car reservation, change of seat for a flight or event, etc. In an example, the processing server 102 can, using APIs, access real-time updates to flight information. When an update for a flight occurs, it can be received by the processing server 102 as event data. The processing server 102 can receive event data of a flight cancellation for a specific flight number. The processing server 102 can identify a smart contract that includes that flight number in the itinerary details, which necessitates a change in the associated itinerary. The processing server 102 can identify that a conflict has occurred due to the change in status of the flight where the itinerary item can no longer be fulfilled due to the cancellation.

When there is a conflict with an itinerary item, the processing server 102 can identify an alternative itinerary item. In some cases, the processing server 102 can identify the closest suitable alternative itinerary item based on the itinerary details. For instance, if the conflicted itinerary item is for a hotel reservation, the processing server 102 can identify an alternative hotel reservation that is of comparable quality and price in a nearby location. In another example, if the conflicted itinerary item is for a flight, the processing server 102 can identify an alternative flight between the same two airports at a nearby time for a comparable price and select a seat that is comparable to the seat in the initial, conflicted itinerary item. The processing server 102 can identify such alternative itinerary items using suitable APIs with the provider systems 106. When an alternative itinerary item is identified, the processing server 102 can make any necessary reservations with the provider system 106 and generate a new, modified smart contract to replace the smart contract for the conflicted itinerary item. The new, modified smart contract can be added to a new blockchain data value that is added to the blockchain using traditional methods or systems. The processing server 102 can also electronically transmit a notification message to the user device 104 to notify the user of the alternative itinerary item.

In some cases, identification of an alternative itinerary item can be an event that is received by the processing server 102 as new event data. In such cases, when the processing server 102 identifies an alternative itinerary item, the processing server 102 can determine if the alternative itinerary item causes a conflict with other itinerary items. For example, if a flight is delayed from noon until 4 pm, it can cause a conflict with a tour reservation for 4 pm that afternoon. The processing server 102 can, as a result of that conflict, identify an alternative tour reservation for 7 pm and generate a new, modified smart contract for the alternative tour reservation and notify the user accordingly. As a result, the overall travel itinerary for a user can be as best preserved as possible.

In some embodiments, the processing server 102 can store account profiles for users. An account profile for a user can store data related to the user's travel preferences, loyalty numbers, funding transaction account data, and other data that can be used by the processing server 102 to identify an overall travel itinerary for the user on their behalf. For instance, as an alternative to the user device 104 submitting travel itinerary items to the processing server 102, the user device 104 can submit criteria for a desired overall travel itinerary, which can be used by the processing server 102, along with their profile, to identify the travel itinerary items used to accomplish the desired overall travel itinerary. For example, the user device 104 can request a five-day beach trip for two during a two-week period from their home city with a desired budget of $1,200. The processing server 102 can communicate with provider systems 106 using APIs to identify flights and a hotel that satisfies the request and budget, make arrangements with the provider systems 106 using the APIs, generate smart contracts for the flight and hotel, store the smart contracts on the blockchain, and provide a notification message to the user device 104 of the booked trip. Using the user's account profile, the processing server 102 can select preferred airlines, preferred seats on the plane, preferred hotel brands, etc. and can use the user's preferred transaction accounts for each reservation as well as any loyalty numbers. The user can then take the trip where payments will be made automatically using their desired transaction accounts without the user having to do anything beyond submitting the initial request. Furthermore, if the flights are delayed or canceled or the hotel reservation is canceled, the processing server 102 will automatically make alternative arrangements for the user and notify them accordingly such that the user will always be able to take their trip after only submitting the initial request.

In some cases, each overall travel itinerary can have a unique identifier associated therewith that can be included in the itinerary details for each smart contract as part of that overall travel itinerary. The unique identifier can be used to quickly identify related smart contracts to identify any conflicts when an alternative itinerary item needs to be identified for one of the itinerary items in the travel itinerary. In other cases, an overall smart contract can be used for managing a group of smart contracts for the itinerary items in an overall travel itinerary. An overall smart contract can be configured to store identifiers or other data for each of the smart contracts for the itinerary items and can be configured to execute when there is a conflict with any of the itinerary items to identify all necessary alternative itinerary items, such as for greater cooperation among alternative itinerary items to reduce future conflicts. In some cases, an overall smart contract can include the user preferences or other requirements for the overall travel itinerary that can be used by the processing server 102 in identifying alternative itinerary items, such as to ensure proper funding transaction accounts or loyalty numbers are used if alternative provider systems 106 are used for alternative itinerary items.

The result is that the system 100 can provide for significantly greater convenience for users in the booking and management of travel itineraries while reducing the need for multiple communications and computer processing power across multiple computer systems of various entities. The use of a blockchain ensures that, when a travel itinerary is set, it cannot be changed or lost, providing peace of mind to the user. The use of smart contracts provides for action that can ensure proper payment to the benefit of provider systems 106 but can also prevent payment when unnecessary to the benefit of users to guarantee that a merchant will not make unauthorized charges to their transaction accounts. The methods and systems discussed herein are also configured to update itinerary items in real-time when conflicts occur without requiring any human intervention, which provides significant benefits to user travels over traditional systems. By identifying conflicts and identifying alternative itinerary items in real-time, any unforeseen circumstances can be swiftly dealt with even without the traveler's knowledge, creating a smoother and less stressful experience. In addition, the storing of alternative itinerary items on a blockchain ensures that the alternative arrangements are indisputable to avoid potential issues during travel, further alleviating potential stress for users, and providing even more significant benefit over traditional systems.

### Processing Server

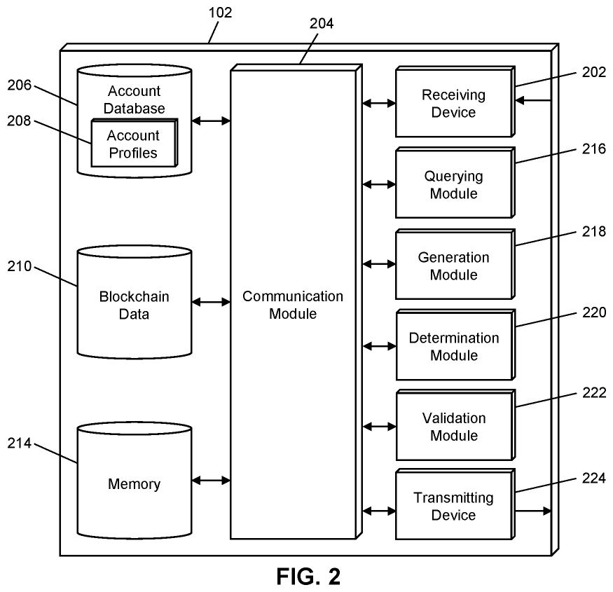

FIG. 2 illustrates an embodiment of a processing server 102. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 600 illustrated in FIG. 6 and discussed in more detail below can be a suitable configuration of the processing server 102. In some cases, additional components of the system 100, such as the user device 104, provider systems 106, issuing financial institutions 108, acquiring financial institutions 110, and blockchain nodes 114, can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from user devices 104, provider systems 106, issuing financial institutions 108, acquiring financial institutions 110, blockchain nodes 114, payment networks 116, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing server 102 to carry out the methods and systems described herein.

The receiving device 202 can be configured to receive data signals electronically transmitted by user devices 104 that can be superimposed or otherwise encoded with loyalty numbers, funding transaction account data, travel preferences, travel itinerary requests, event data, itinerary items, etc. The receiving device 202 can also be configured to receive data signals electronically transmitted by provider systems 106 that can be superimposed or otherwise encoded with itinerary details, event data, availability information, payee data, etc. The receiving device 202 can also be configured to receive data signals electronically transmitted by issuing financial institutions 108, acquiring financial institutions 110, and payment networks 116 that can be superimposed or otherwise encoded with event data, funding transaction account data, payee data, routing numbers, account numbers, merchant identification numbers, prices, fees, transaction messages, etc. The receiving device 202 can also be configured to receive data signals electronically transmitted by blockchain nodes 114, which can be superimposed or otherwise encoded with blockchain data values, blocks, response messages, cryptographic keys, smart contracts, event data, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, determination module 220, validation module 222, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a user profile that can include, for example, funding transaction account data, loyalty numbers, known traveler numbers, names, dates of birth, email addresses, telephone numbers, seat preferences, class preferences, airline preferences, budget criteria, brand preferences, etc.

The processing server 102 can also include blockchain data 210, which can be stored in a memory 214 of the processing server 102 or stored in a separate area within the computing system 200 or accessible thereby. The blockchain data 210 can include a blockchain, which may be comprised of a plurality of blocks and be associated with the blockchain networks 114. In some cases, the blockchain data 210 can further include any other data associated with the blockchain and management and performance thereof, such as block generation algorithms, digital signature generation and confirmation algorithms, communication data for blockchain nodes 114, smart contracts, geographic keys, etc. The blockchain data 210 can also include data used by the processing server 102 for actions associated with a blockchain, such as cryptographic key pairs for blockchain wallets, public keys for generating destination addresses or validating digital signatures, transaction histories, cryptocurrency amounts, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, geographic keys, smart contracts, API communication data, itinerary details, unique identifiers, etc.

The processing server 102 can include a querying module 216. The querying module 216 can be configured to execute queries on databases to identify information. The querying module 216 can receive one or more data values or query strings and can execute a query string based thereon on an indicated database, such as the account database 206 of the processing server 102 to identify information stored therein. The querying module 216 can then output the identified information to an appropriate engine or module of the processing server 102 as necessary. The querying module 216 can, for example, execute a query on the account database 206 to identify an account profile 208 to identify preferences and loyalty numbers when identifying new or alternative itinerary items.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate data messages, notification messages, cryptographic keys, blockchain transactions, blockchain data values, smart contracts, etc.

The processing server 102 can also include a determination module 220. The determination module 220 can be configured to perform determinations for use by the processing server 102 in performing the functions discussed herein. The determination module 220 can receive instructions as input, can make determinations based on the instructions, and can output the determinations to one or more modules of the processing server 102. For example, the determination module 220 can be configured to determine itinerary items, determine alternative itinerary items, determine conflicts between event data and itinerary items, etc.

The processing server 102 can also include a validation module 222. The validation module 222 can be configured to perform validations for the processing server 102 as part of the functions discussed herein. The validation module 222 can receive instructions as input, which can also include data to be used in performing a validation, can perform a validation as requested, and can output a result of the validation to another module or engine of the processing server 102. The validation module 222 can, for example, be configured to validate blockchain transactions, validate fulfillment of itinerary criteria, validate compliance of itinerary items with a user's travel request, etc.

The processing server 102 can also include a transmitting device 224. The transmitting device 224 can be configured to transmit data over one or more networks via one or more network protocols. In some instances, the transmitting device 224 can be configured to transmit data to user devices 104, provider systems 106, issuing financial institutions 108, acquiring financial institutions 110, blockchain nodes 114, payment networks 116, and other entities via one or more communication methods, local area networks, wireless area networks, cellular communication, Bluetooth, radio frequency, the Internet, etc. In some embodiments, the transmitting device 224 can be comprised of multiple devices, such as different transmitting devices for transmitting data over different networks, such as a first transmitting device for transmitting data over a local area network and a second transmitting device for transmitting data via the Internet. The transmitting device 224 can electronically transmit data signals that have data superimposed that can be parsed by a receiving computing device. In some instances, the transmitting device 224 can include one or more modules for superimposing, encoding, or otherwise formatting data into data signals suitable for transmission.

The transmitting device 224 can be configured to electronically transmit data signals to user devices 104 that can be superimposed or otherwise encoded with notification messages, itinerary details, requests for funding transaction account data, requests for travel preferences, etc. The transmitting device 224 can also be configured to electronically transmits data signals to provider systems 106, which can be superimposed or otherwise encoded with notification messages, requests for itinerary details, requests for availability data, requests for payee data, etc. The transmitting device 224 can also be configured to electronically transmit data signals to issuing financial institutions 108, acquiring financial institutions 110, and payment networks 116 that can be superimposed or otherwise encoded with transaction messages, authorization requests, requests for transaction account data, requests for event data, notification messages, etc. The transmitting device 224 can also be configured to electronically transmit data signals to blockchain nodes 114, which can be superimposed or otherwise encoded with smart contracts, blockchain data, blocks, blockchain data values, cryptographic keys, response messages, requests for blockchain data, etc.

### Process for Creation of New Travel Itineraries Using a Blockchain

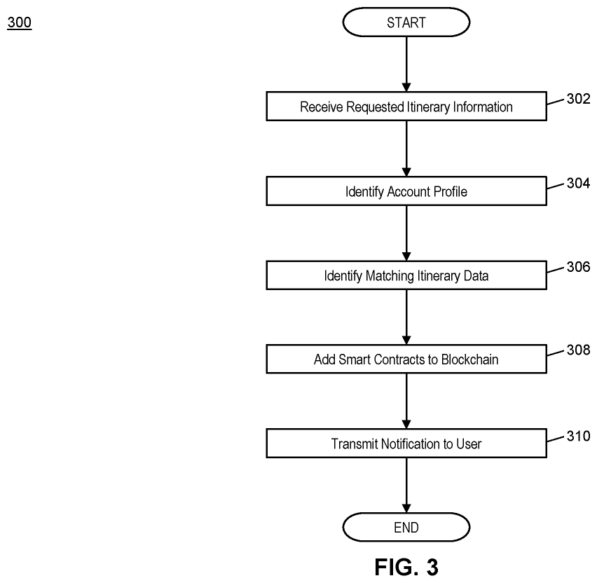

FIG. 3 illustrates a process 300 for the creation of new itinerary items for a travel itinerary managed using a blockchain as performed by the processing server 102 in the system 100 of FIG. 1.

In step 302, the receiving device 202 of the processing server 102 can receive requested itinerary information, such as from the user device 104 submitting using a suitable communication network and method. The requested itinerary information can include one or more criteria regarding a requested trip, such as a location, dates, budget, etc., and can also include an identifier associated with a user profile. In step 304, the querying module 216 of the processing server 102 can execute a query on the account database 206 of the processing server 102 to identify an account profile 208 associated with the user using the identifier.

In step 306, the determination module 220 of the processing server 102 can determine itinerary items that match the one or more criteria for the requested trip and satisfy any preferences and requirements included in the identified account profile 208. The determination module 220 can, such as using the transmitting device 224 and receiving device 202 of the processing server 102, access information from provider systems 106 using APIs therewith to identify potential flights, hotels, etc. to satisfy the requested trip. Once the determination module 220 has identified the itinerary items, the generation module 218 of the processing server 102 can generate a smart contract for each of the itinerary items that includes the itinerary details for each itinerary item and is configured to, when executed upon fulfillment of one or more criteria, initiate a payment transaction for payment from the user to the appropriate service provider.

In step 308, the transmitting device 224 of the processing server 102 can electronically transmit the generated smart contracts to a blockchain node 114 in the blockchain network 112 for inclusion in a new blockchain data value that is added to a new block that is added to the blockchain. In step 310, the transmitting device 224 of the processing server 102 can electronically transmit a notification message to the user via their user device 104 using a suitable communication network and method. The notification message can include details regarding the itinerary items that were identified by the processing server 102 for the requested trip and reserved on behalf of the user, such as times, dates, flight numbers, booking numbers, hotel addresses, airlines, reserved tours, restaurant reservations, etc.

### Process for Real-Time Management and Updating of Itinerary Items Using a Blockchain

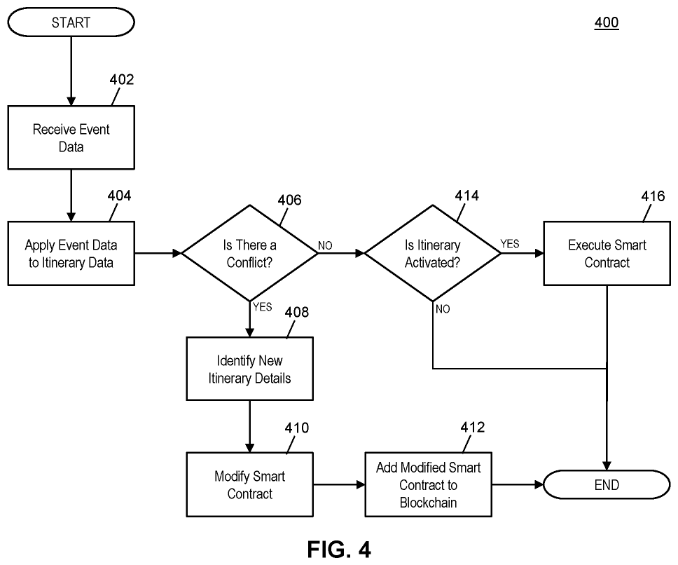

FIG. 4 illustrates a process 400 for the management and updating of itinerary items in real-time using a blockchain as performed by the processing server 102 in the system 100 of FIG. 1, such as the updating of itinerary items made using the process 300 in FIG. 3, discussed above.

In step 402, the receiving device 202 of the processing server 102 can receive event data. Event data can include details regarding an event, such as dates, times, status changes, check-in information, booking numbers, reservation numbers, etc. The event data can be received from any entity or system, such as a user device 104, provider system 106, or other module of the processing server 102. In step 404, the determination module 220 of the processing server 102 can apply the event data to itinerary details for an itinerary item whose smart contract is still active (e.g., not expired) stored in the blockchain data 210 in the processing server 102. Application of the event data can include matching data fields in the event data to data fields in the itinerary details, such as matching dates, times, booking numbers, etc. In step 406, the determination module 220 of the processing server 102 can determine if there is a conflict between event data and itinerary details. A conflict can include, for example, a change in a flight time, a cancellation or delay in a flight or concert, etc.

If the determination module 220 determines that there is a conflict, then, in step 408, the determination module 220 of the processing server 102 can identify new itinerary details for an alternative itinerary item that satisfies any user preferences and requirements as well as any requirements for the overall travel itinerary, which can be found in an account profile 208 or overall smart contract. In step 410, the generation module 218 of the processing server 102 can generate a modified smart contract, which is a smart contract that includes the new itinerary details as well as the funding transaction account data and payee data for payment and is still configured to initiate a payment transaction upon fulfillment of the criteria. In step 412, the transmitting device 224 of the processing server 102 can electronically transmit the modified smart contract to a blockchain node 114 in the blockchain network 112 for inclusion in a new block that is added to the blockchain. In some cases, the transmitting device 224 can also transmit a notification message to the user device 104 to inform the user of the modification to the itinerary item. The process 400 can then be completed for the itinerary item until new event data is received.

If, in step 406, the determination module 220 determined that there was no conflict, then, in step 414, the determination module 220 determines if the itinerary is activated. The itinerary can be activated if the one or more criteria in the itinerary details are fulfilled according to the event data. Fulfillment of the criteria can include the passage of a start time for an event or restaurant reservation or check-in by the user for a flight or hotel reservation. If, in step 414, the determination module 220 determines that the itinerary is not activated, then the process 400 can be completed as the processing server 102 can await new event data that could affect the itinerary item. If, in step 414, the determination module 220 determines that the itinerary is activated, then, in step 416, the smart contract for the itinerary item can be executed on the blockchain. Execution of the smart contract can result in the initiation of a payment transaction for payment of the amount included in the itinerary details from the user (e.g., via a transaction account identified using the funding transaction account data) to the service provider (e.g., to a transaction account identified using the payee data). The process 400 can then be completed for that itinerary item following its fulfillment.

### Exemplary Method for Real-Time Management of Travel Itineraries

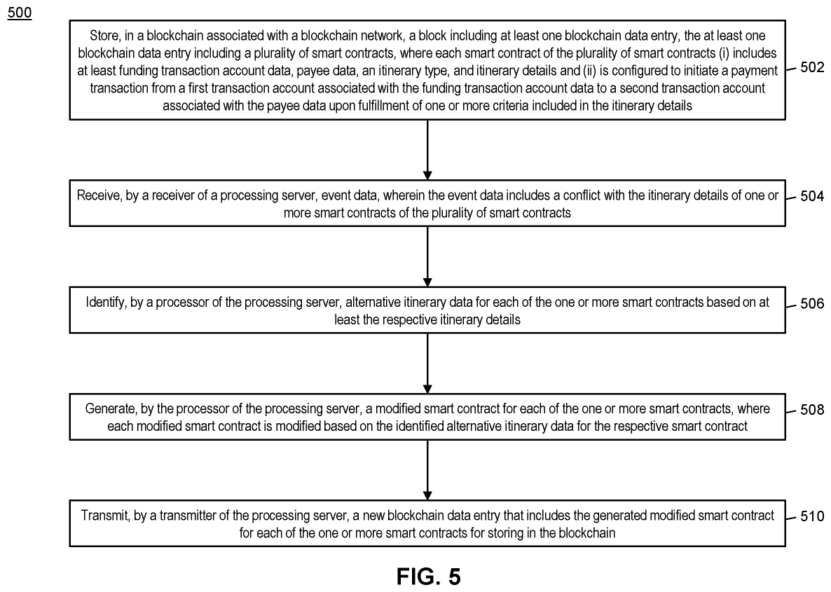

FIG. 5 illustrates a method 500 for the management, payment, and real-time updating of travel itineraries using a blockchain.

In step 502, a block can be stored in a blockchain associated with a blockchain network (e.g., blockchain network 112), the block including at least one blockchain data entry, the at least one blockchain data entry including a plurality of smart contracts, where each smart contract of the plurality of smart contracts (i) includes at least funding transaction account data, payee data, an itinerary type, and itinerary details and (ii) is configured to initiate a payment transaction from a first transaction account associated with the funding transaction account data to a second transaction account associated with the payee data upon fulfillment of one or more criteria included in the itinerary details. In step 504, event data can be received by a receiver (e.g., receiving device 202) of a processing server (e.g., processing server 102), wherein the event data includes a conflict with the itinerary details of one or more smart contracts of the plurality of smart contracts.

In step 506, alternative itinerary data can be identified by a processor (e.g., determination module 220) of the processing server for each of the one or more smart contracts based on at least the respective itinerary details. In step 508, a modified smart contract can be generated by the processor (e.g., generation module 218) of the processing server for each of the one or more smart contracts, where each modified smart contract is modified based on the identified alternative itinerary data for the respective smart contract. In step 510, a new blockchain data entry that includes the generated modified smart contract for each of the one or more smart contracts can be transmitted by a transmitter (e.g., transmitting device 224) of the processing server for storing in the blockchain.

In one embodiment, the method 500 can further include storing, in an account database (e.g., account database 206) of the processing server, an account profile (e.g., account profile 208) including at least a profile identifier, wherein each smart contract of the plurality of smart contracts can further include the profile identifier. In a further embodiment, the account profile can further include one or more travel preferences, and identifying the alternative itinerary data for each of the one or more smart contracts can be further based on the one or more travel preferences. In an even further embodiment, the one or more travel preferences can include a budget amount.

In some embodiments, the method 500 can also include executing, by the processor of the processing server, each modified smart contract, wherein each modified smart contract is executed upon fulfillment of one or more criteria included in the alternative itinerary data, and wherein execution of the modified smart contract comprises initiating a payment transaction from a first transaction account associated with the funding transaction account data of the modified smart contract to a second transaction account associated with the payee data of the modified smart contract. In one embodiment, itinerary type can include at least one of: flight, rental car, hotel, train, and admission. In some embodiments, itinerary details can include at least one of: date, time, price, seat, class, taxes, fees, length, layover, and street address. In one embodiment, generating the modified smart contract for each of the one or more smart contracts can further comprise generating new event data for each modified smart contract, wherein the new event data is based on at least the alternative itinerary details.

### Computer System Architecture

FIG. 6 illustrates a computer system 600 in which embodiments of the present disclosure, or portions thereof, can be implemented as computer-readable code. For example, the processing server 102, user device 106, provider systems 106, issuing financial institutions 108, acquiring financial institutions 110, and blockchain nodes 114 can be implemented in the computer system 600 using hardware, non-transitory computer readable media having instructions stored thereon, or a combination thereof and can be implemented in one or more computer systems or other processing systems. Hardware can embody modules and components used to implement the methods of FIGS. 3-5.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 604 can be a special purpose or a general-purpose processor device specifically configured to perform the functions discussed herein. The processor device 604 can be connected to a communications infrastructure 606, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 can also include a main memory 608 (e.g., random access memory, read-only memory, etc.), and can also include a secondary memory 610. The secondary memory 610 can include the hard disk drive 612 and a removable storage drive 614, such as a floppy disk drive, a magnetic tape drive, an optical disk drive, a flash memory, etc.

The removable storage drive 614 can read from and/or write to the removable storage unit 618 in a well-known manner. The removable storage unit 618 can include a removable storage media that can be read by and written to by the removable storage drive 614. For example, if the removable storage drive 614 is a floppy disk drive or universal serial bus port, the removable storage unit 618 can be a floppy disk or portable flash drive, respectively. In one embodiment, the removable storage unit 618 can be non-transitory computer readable recording media.

In some embodiments, the secondary memory 610 can include alternative means for allowing computer programs or other instructions to be loaded into the computer system 600, for example, the removable storage unit 622 and an interface 620. Examples of such means can include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 600 can also include a communications interface 624. The communications interface 624 can be configured to allow software and data to be transferred between the computer system 600 and external devices. Exemplary communications interfaces 624 can include a modem, a network interface (e.g., an Ethernet card), a communications port, a PCMCIA slot and card, etc. Software and data transferred via the communications interface 624 can be in the form of signals, which can be electronic, electromagnetic, optical, or other signals as will be apparent to persons having skill in the relevant art. The signals can travel via a communications path 626, which can be configured to carry the signals and can be implemented using wire, cable, fiber optics, a phone line, a cellular phone link, a radio frequency link, etc.

The computer system 600 can further include a display interface 602. The display interface 602 can be configured to allow data to be transferred between the computer system 600 and external display 630. Exemplary display interfaces 602 can include high-definition multimedia interface (HDMI), digital visual interface (DVI), video graphics array (VGA), etc. The display 630 can be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 608 and secondary memory 610, which can be memory semiconductors (e.g., DRAMs, etc.). These computer program products can be means for providing software to the computer system 600. Computer programs (e.g., computer control logic) can be stored in the main memory 608 and/or the secondary memory 610. Computer programs can also be received via the communications interface 624. Such computer programs, when executed, can enable computer system 600 to implement the present methods as discussed herein. In particular, the computer programs, when executed, can enable processor device 604 to implement the methods illustrated by FIGS. 3-5, as discussed herein. Accordingly, such computer programs can represent controllers of the computer system 600. Where the present disclosure is implemented using software, the software can be stored in a computer program product and loaded into the computer system 600 using the removable storage drive 614, interface 620, and hard disk drive 612, or communications interface 624.

The processor device 604 can comprise one or more modules or engines configured to perform the functions of the computer system 600. Each of the modules or engines can be implemented using hardware and, in some instances, can also utilize software, such as corresponding to program code and/or programs stored in the main memory 608 or secondary memory 610. In such instances, program code can be compiled by the processor device 604 (e.g., by a compiling module or engine) prior to execution by the hardware of the computer system 600. For example, the program code can be source code written in a programming language that is translated into a lower-level language, such as assembly language or machine code, for execution by the processor device 604 and/or any additional hardware components of the computer system 600. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for management, payment, and real-time updating of travel itineraries using a blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for management, payment, and real-time updating of travel itineraries using a blockchain, comprising:
storing, in a blockchain associated with a blockchain network, a block including at least one blockchain data entry, the at least one blockchain data entry including a plurality of smart contracts, where each smart contract of the plurality of smart contracts (i) includes at least funding transaction account data, payee data, an itinerary type, and itinerary details and (ii) is configured to initiate a payment transaction from a first transaction account associated with the funding transaction account data to a second transaction account associated with the payee data upon fulfillment of one or more criteria included in the itinerary details;
receiving, by a receiver of a processing server, event data, wherein the event data includes a conflict with the itinerary details of one or more smart contracts of the plurality of smart contracts;
identifying, by a processor of the processing server, alternative itinerary data for each of the one or more smart contracts based on at least the respective itinerary details;
generating, by the processor of the processing server, a modified smart contract for each of the one or more smart contracts, where each modified smart contract is modified based on the identified alternative itinerary data for the respective smart contract; and
transmitting, by a transmitter of the processing server, a new blockchain data entry that includes the generated modified smart contract for each of the one or more smart contracts for storing in the blockchain.

2. The method of claim 1, further comprising:
storing, in an account database of the processing server, an account profile including at least a profile identifier, wherein
each smart contract of the plurality of smart contracts further includes the profile identifier.

3. The method of claim 2, wherein
the account profile further includes one or more travel preferences, and identifying the alternative itinerary data for each of the one or more smart contracts is further based on the one or more travel preferences.

4. The method of claim 3, wherein the one or more travel preferences includes a budget amount.

5. The method of claim 1, further comprising:
executing, by the processor of the processing server, each modified smart contract, wherein each modified smart contract is executed upon fulfillment of one or more criteria included in the alternative itinerary data, and wherein execution of the modified smart contract comprises initiating a payment transaction from a first transaction account associated with the funding transaction account data of the modified smart contract to a second transaction account associated with the payee data of the modified smart contract.

6. The method of claim 1, wherein itinerary type includes at least one of:
flight, rental car, hotel, train, and admission.

7. The method of claim 1, wherein itinerary details includes at least one of:
date, time, price, seat, class, taxes, fees, length, layover, and street address.

8. The method of claim 1, wherein generating the modified smart contract for each of the one or more smart contracts further comprises generating new event data for each modified smart contract, wherein the new event data is based on at least the alternative itinerary details.

9. A system for management, payment, and real-time updating of travel itineraries using a blockchain, comprising:
a blockchain associated with a blockchain network, the blockchain storing a block including at least one blockchain data entry, the at least one blockchain data entry including a plurality of smart contracts, where each smart contract of the plurality of smart contracts (i) includes at least funding transaction account data, payee data, an itinerary type, and itinerary details and (ii) is configured to initiate a payment transaction from a first transaction account associated with the funding transaction account data to a second transaction account associated with the payee data upon fulfillment of one or more criteria included in the itinerary details; and
a processing server including
a receiver receiving event data, wherein the event data includes a conflict with the itinerary details of one or more smart contracts of the plurality of smart contracts,
a processor
identifying alternative itinerary data for each of the one or more smart contracts based on at least the respective itinerary details, and
generating a modified smart contract for each of the one or more smart contracts, where each modified smart contract is modified based on the identified alternative itinerary data for the respective smart contract, and
a transmitter transmitting a new blockchain data entry that includes the generated modified smart contract for each of the one or more smart contracts for storing in the blockchain.

10. The system of claim 9, wherein
the processing server further includes an account database storing an account profile including at least a profile identifier, and
each smart contract of the plurality of smart contracts further includes the profile identifier.

11. The system of claim 10, wherein
the account profile further includes one or more travel preferences, and
identifying the alternative itinerary data for each of the one or more smart contracts is further based on the one or more travel preferences.

12. The system of claim 11, wherein the one or more travel preferences includes a budget amount.

13. The system of claim 9, wherein the processor of the processing server executes each modified smart contract, each modified smart contract is executed upon fulfillment of one or more criteria included in the alternative itinerary data, and execution of the modified smart contract comprises initiating a payment transaction from a first transaction account associated with the funding transaction account data of the modified smart contract to a second transaction account associated with the payee data of the modified smart contract.

14. The system of claim 9, wherein itinerary type includes at least one of:
flight, rental car, hotel, train, and admission.

15. The system of claim 9, wherein itinerary details includes at least one of:
date, time, price, seat, class, taxes, fees, length, layover, and street address.

16. The system of claim 9, wherein generating the modified smart contract for each of the one or more smart contracts further comprises generating new event data for each modified smart contract, wherein the new event data is based on at least the alternative itinerary details.
